(19) United States
(12) Patent Application Publication
(10) Pub. No.: US 2024/0292324 A1
(43) Pub. Date: Aug. 29, 2024

(54) DYNAMIC NETWORK-SIDE CELL DISCONTINUOUS RECEPTION (DRX) CONTROL AND SCHEDULING

(71) Applicant: QUALCOMM Incorporated, San Diego, CA (US)

(72) Inventors: Diana Maamari, San Diego, CA (US); Huilin Xu, Temecula, CA (US); Hung Dinh Ly, San Diego, CA (US); Ahmed Elshafie, San Diego, CA (US); Ahmed Attia Abotabl, San Diego, CA (US)

(21) Appl. No.: 18/174,489

(22) Filed: Feb. 24, 2023

(51) Int. Cl. H04W 52/02; H04W 72/23

(52) U.S. Cl. CPC H04W 52/0216; H04W 52/0232; H04W 72/23

(57) ABSTRACT

This disclosure provides systems, methods, and devices for wireless communication that support dynamic network-side cell discontinuous reception (DRX) control and scheduling. In a first aspect, a method of wireless communication includes transmitting an end of transmit (TX) traffic indicator. The method also includes receiving an early termination indicator associated with a scheduled network-side cell discontinuous reception (DRX) active time. The method further includes refraining from transmitting data traffic during at least a remainder of the scheduled network-side cell DRX active time. Other aspects and features are also claimed and described.

### TECHNICAL FIELD

Aspects of the present disclosure relate generally to wireless communication systems, and more particularly, to dynamic network-side cell discontinuous reception (DRX) control and scheduling. Some features may enable and provide improved communications, including efficient resource utilization and reduced power consumption at network devices.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

As wireless communication devices become increasingly a part of daily life, there is an increased drive to provide wireless communication capability to a broader variety of devices. In particular, there is demand to expand current wireless communication and connectivity capabilities of mobile phones and computers to less complicated devices such as wireless sensors, internet of things (IoT) devices, smart devices, and the like. One challenge with extending wireless communication capabilities to such devices is the power consumption associated with wireless communications may exceed the limited battery or power resources of these devices. As such, several advances have been made in order to conserve power at user equipments (UEs), including defining limited time periods when the UEs are required to perform wireless communications, thereby enabling the UEs to spend a remainder of the time in a low power operating mode (e.g., a sleep mode) to conserve power. However, similar techniques have not been extended to base stations and other network-side devices, possibly due to assumptions that such devices would be coupled to a fixed power source. As technology has advanced, network entities such as base stations have become smaller and more mobile than expected, and functionality has begun to be divided between multiple devices, some of which may not be coupled to a fixed power source. As such, conserving power at network-side devices, in addition to UEs, is becoming increasingly desirable.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication is performed by a user equipment (UE). The method includes transmitting an end of transmit (TX) traffic indicator. The method also includes receiving an early termination indicator associated with a scheduled network-side cell discontinuous reception (DRX) active time. The method further includes refraining from transmitting data traffic during at least a remainder of the scheduled network-side cell DRX active time.

In an additional aspect of the disclosure, a UE includes a memory and at least one processor coupled to the memory. The memory stores processor-readable code. The at least one processor is configured to execute the processor-readable code to cause the at least one processor to initiate transmission of an end of TX traffic indicator. Execution of the processor-readable code also causes the at least one processor to receive an early termination indicator associated with a scheduled network-side cell DRX active time. Execution of the processor-readable code further causes the at least one processor to refrain from transmitting data traffic during at least a remainder of the scheduled network-side cell DRX active time.

In an additional aspect of the disclosure, an apparatus includes means for transmitting an end of TX traffic indicator. The apparatus also includes means for receiving an early termination indicator associated with a scheduled network-side cell DRX active time. The apparatus further includes means for refraining from transmitting data traffic during at least a remainder of the scheduled network-side cell DRX active time.

In an additional aspect of the disclosure, a non-transitory computer-readable medium stores instructions that, when executed by a processor, cause the processor to perform operations. The operations include initiating transmission of an end of TX traffic indicator. The operations also include receiving an early termination indicator associated with a scheduled network-side cell DRX active time. The operations further include refraining from transmitting data traffic during at least a remainder of the scheduled network-side cell DRX active time.

In an additional aspect of the disclosure, an apparatus includes at least one processor coupled to a memory storing processor-readable code. The at least one processor is configured to execute the processor-readable code to cause the at least one processor to initiate transmission of an end of TX traffic indicator. The apparatus further includes a communication interface configured to receive an early termination indicator associated with a scheduled network-side cell DRX active time. Execution of the processor-readable code further causes the at least one processor to refrain from initiating transmission of data traffic during at least a remainder of the scheduled network-side cell DRX active time.

In an additional aspect of the disclosure, a method for wireless communication is performed by a network entity. The method includes receiving one or more end of TX traffic indicators. The method further includes transmitting an early termination indicator associated with a scheduled network-side cell DRX active time based on receipt of the one or more end of TX traffic indicators.

In an additional aspect of the disclosure, a base station includes a memory and at least one processor coupled to the memory. The memory stores processor-readable code. The at least one processor is configured to execute the processor-readable code to cause the at least one processor to receive one or more end of TX traffic indicators. Execution of the processor-readable code also causes the at least one processor to initiate transmission of an early termination indicator associated with a scheduled network-side cell DRX active time based on receipt of the one or more end of TX traffic indicators.

In an additional aspect of the disclosure, an apparatus includes means for receiving one or more end of TX traffic indicators. The apparatus further includes means for transmitting an early termination indicator associated with a scheduled network-side cell DRX active time based on receipt of the one or more end of TX traffic indicators.

In an additional aspect of the disclosure, a non-transitory computer-readable medium stores instructions that, when executed by a processor, cause the processor to perform operations. The operations include receiving one or more end of TX traffic indicators. The operations further include initiating transmission of an early termination indicator associated with a scheduled network-side cell DRX active time based on receipt of the one or more end of TX traffic indicators.

In an additional aspect of the disclosure, an apparatus includes at least one processor coupled to a memory storing processor-readable code. The at least one processor is configured to execute the processor-readable code to cause the at least one processor to receive one or more end of TX traffic indicators. The apparatus further includes a communication interface configured to transmit an early termination indicator associated with a scheduled network-side cell DRX active time based on receipt of the one or more end of TX traffic indicators.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 shows a diagram illustrating an example disaggregated base station architecture according to one or more aspects.

FIG. 4 is a block diagram illustrating an example wireless communication system that supports dynamic network-side cell discontinuous reception (DRX) control and scheduling according to one or more aspects.

FIG. 5 shows multiple examples of network-side cell DRX active time periods according to one or more aspects.

FIG. 6 is a ladder diagram illustrating an example process that supports dynamic network-side cell DRX control and scheduling according to one or more aspects.

FIG. 7 is a flow diagram illustrating an example process that supports dynamic network-side cell DRX control and scheduling according to one or more aspects.

FIG. 8 is a block diagram of an example UE that supports dynamic network-side cell DRX control and scheduling according to one or more aspects.

FIG. 9 is a flow diagram illustrating an example process that supports dynamic network-side cell DRX control and scheduling according to one or more aspects.

FIG. 10 is a block diagram of an example base station that supports dynamic network-side cell DRX control and scheduling according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support dynamic network-side cell discontinuous reception (DRX) control and scheduling. For example, the present disclosure describes techniques for enabling a network entity, such as a base station, to dynamically determine whether to early terminate one or more scheduled network-side cell DRX active time periods. To illustrate, the base station may determine to terminate scheduled network-side cell DRX active time period(s) based on receipt of an end of transmit (TX) traffic indicator from a user equipment (UE). As used herein, network-side cell DRX active time periods refer to time periods during which the base station, or other network entity, actively monitors for uplink (UL) communications from one or more UEs within a serving cell. The active time periods may be followed by inactive time periods, thereby resulting in a periodic pattern of active durations and inactive durations at the base station. By early terminating one or more of these active time periods, the combined terminated active time periods and intervening inactive time periods may be used by the base station to transition into a lower power operating mode (e.g., a sleep mode) that conserves power at the base station. The base station may communicate an indicator of this early termination to UEs within the serving cell so that the UEs may take appropriate actions during this time, such as buffering new TX data packets or requesting scheduling of new network-side cell DRX.

To illustrate, a UE served by a base station may determine that there is no additional TX traffic to be transmitted as part of a current TX burst on the UL to the base station. For example, the UE may receive an end of TX traffic indicator from a higher layer application that is executed by the UE, such as a streaming media application, a virtual reality (VR), augmented reality (AR), or extended reality (XR) application, a video game, or the like. The UE may transmit the end of TX traffic indicator to the base station, such as by transmitting a zero buffer indicator or an end of TX burst indicator, as non-limiting examples. In response to receiving the end of traffic indicator, the base station may determine whether to early terminate scheduled network-side cell DRX active time. For example, if the UE is the only UE currently active within the serving cell, the base station may determine to perform the early termination based on receipt of the end of traffic indicator. Alternatively, if multiple UEs are active within the serving cell, the base station may determine whether to perform the early termination based on whether corresponding end of traffic indicators have been received from all of the UEs in the serving cell, whether corresponding end of traffic indicators have been received from a threshold number of UEs within the serving cell, based on latency or priority parameters associated with the UEs within the serving cell and any received end of traffic indicators, other parameters, or a combination thereof.

If the base station determines to perform early termination of the network-side cell DRX active time, the base station may transmit an early termination indicator to the UE (and to other UEs if multiple UEs are active within the serving cell). For example, the early termination indicator may be included in downlink control information (DCI) transmitted by the base station via a physical downlink control channel (PDCCH). In some implementations, the early termination indicator may be a single bit of a group DCI that indicates whether scheduled network-side cell DRX active times are terminated. Alternatively, the early termination indicator may be included in a medium access control (MAC) control element (MAC-CE), a radio resource control (RRC) message, or another type of message from the base station. Based on receiving the early termination indicator, the UE may refrain from transmitting data traffic (e.g., TX/UL data) during at least a remainder of the scheduled network-side cell DRX active time. For example, if the higher layer application at the UE generates additional data packets for transmission, the UE may delay transmission of the data packets until network-side cell DRX is re-established (e.g., rescheduled).

In some implementations, the early termination indicator includes a duration of the active time termination. For example, the early termination indicator may indicate a particular amount of time (e.g., in milliseconds (ms)), a particular number of cell DRX active cycles, or the like, that are terminated. The duration may be based on a duration indicated by the UE. For example, the UE may transmit the end of TX traffic indicator with or including a duration that represents an expected duration for which no TX traffic will be available, and the base station may terminate the cell DRX active time periods for this duration. After the particular duration, network-side cell DRX active time may occur as previously scheduled (e.g., according to the previously scheduled periodic cycle). In some other implementations, the early termination indicator may indicate that the termination of cell DRX active time is an indefinite termination (e.g., no duration may be indicated by the early termination indicator). In some such implementations, the base station may terminate all scheduled cell DRX active times. If a UE determines that it has new TX traffic to send to the base station, the UE may transmit a network-side cell DRX request to the base station. The network-side cell DRX request may include or correspond to a scheduling request (SR) or a cell wake-up signal (CWUS), and the base station may be configured to monitor for this particular type of signal while operating in the low power operating mode. In response to receiving the network-side cell DRX request, the base station may transmit a scheduling message for a new scheduled DRX active time, and the UE may use the received scheduling message to determine when to transmit the new TX data to the base station.

Particular implementations of the subject matter described in this disclosure may be implemented to realize one or more of the following potential advantages or benefits. In some aspects, the present disclosure provides techniques for dynamic network-side cell DRX control and scheduling. The techniques described enable a network entity, such as a base station, to dynamically determine whether to terminate scheduled network-side cell DRX active time period(s), thereby enabling the network entity to enter a low power operating mode (e.g., a sleep mode) and conserve power. The determination may be based on information from one or more UEs within a serving cell, such as end of TX traffic indicators, that indicate that the UEs will not be transmitting during the scheduled network-side cell DRX active time period(s). Because the UEs will not be transmitting during these active times, the network entity may enter the sleep mode with minimal to no impact on latency and throughput at the UEs. As such, the techniques described herein enable improved communications, including efficient resource utilization (e.g., less interference with other devices during terminate network-side cell DRX active time periods) and reduced power consumption at the network entity. Additionally, in some implementations, the UE may be enabled to request rescheduling of cell DRX active time periods if additional TX traffic is generated by transmitting a network-side cell DRX request, thereby providing for UEs or applications with low latency requirements the ability to quickly re-instate network-side cell DRX.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km2), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.99999% reliability), ultra-low latency (e.g., ˜1 millisecond (ms)), and users with wide ranges of mobility or lack thereof, and (3) with enhanced mobile broadband including extreme high capacity (e.g., ˜10 Tbps/km2), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

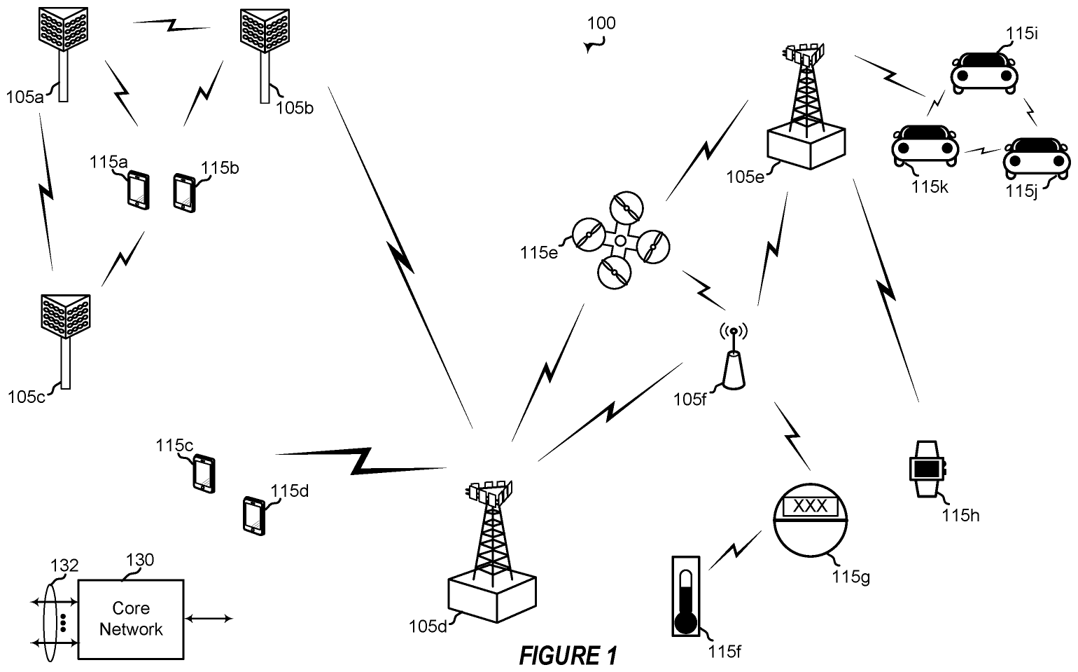

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100. A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

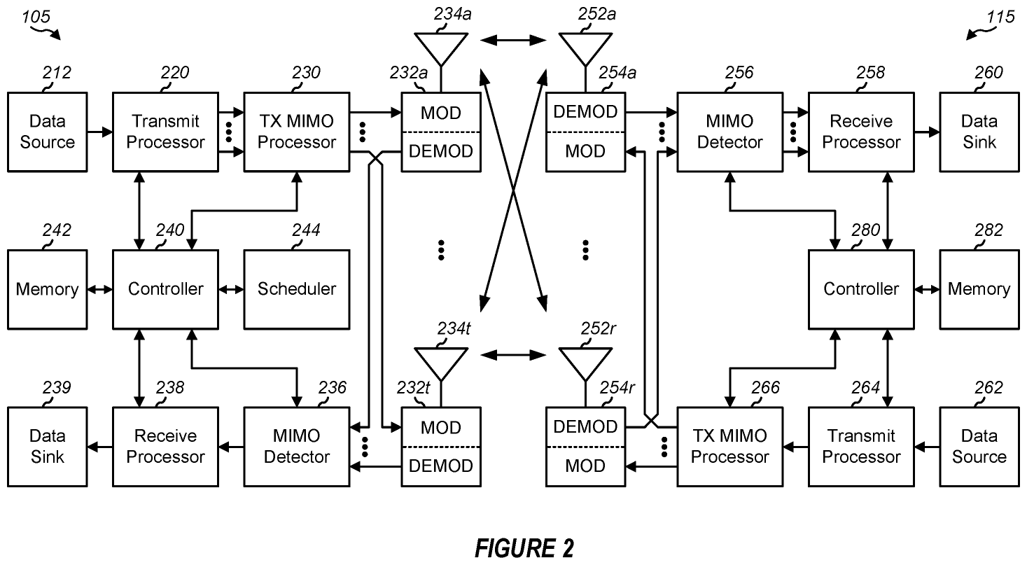

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

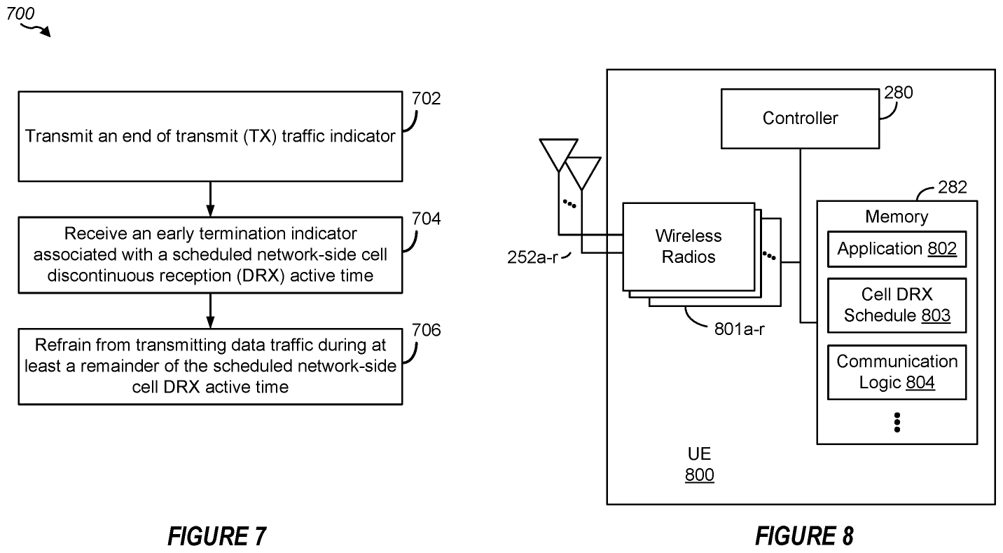

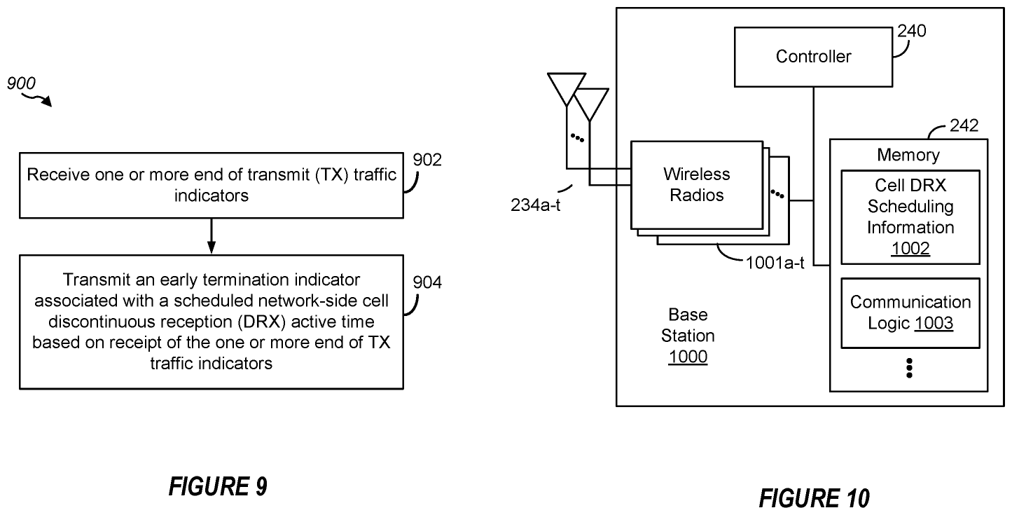

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 7 and 9, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

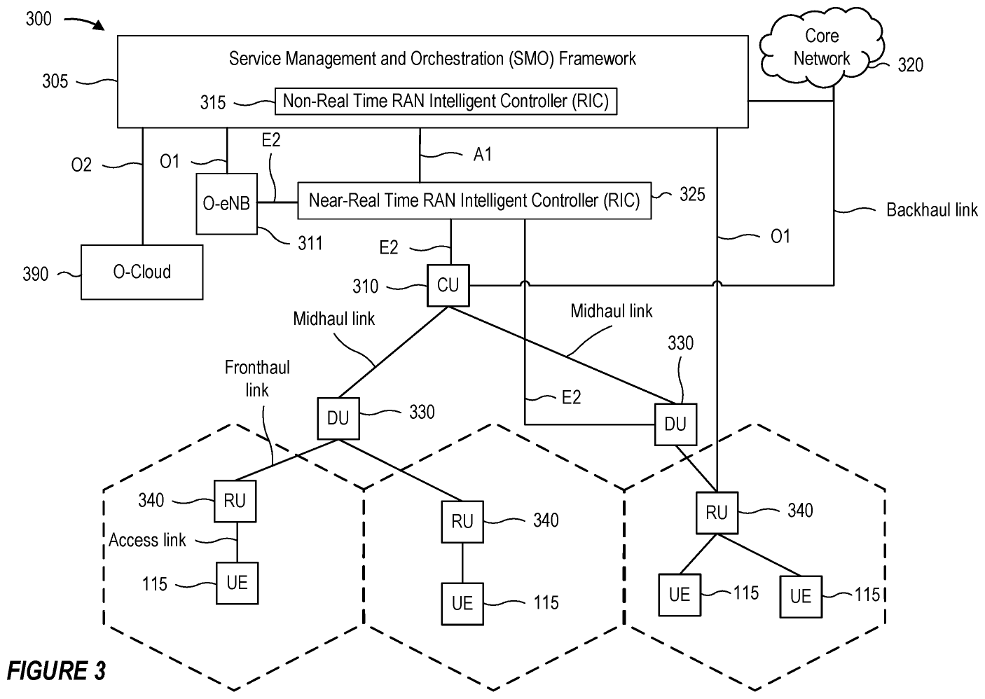

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). Core network 320 may include or correspond to core network 130. A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 115 via one or more radio frequency (RF) access links. In some implementations, the UE 115 may be simultaneously served by multiple RUs 340.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 115. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As described herein, a node (which may be referred to as a node, a network node, a network entity, or a wireless node) may include, be, or be included in (e.g., be a component of) a base station (e.g., any base station described herein), a transmission and reception point (TRP), a UE (e.g., any UE described herein), a network controller, an apparatus, a device, a computing system, an integrated access and backhauling (IAB) node, a distributed unit (DU), a central unit (CU), a remote unit (RU), a core network, a LFM, and/or a another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

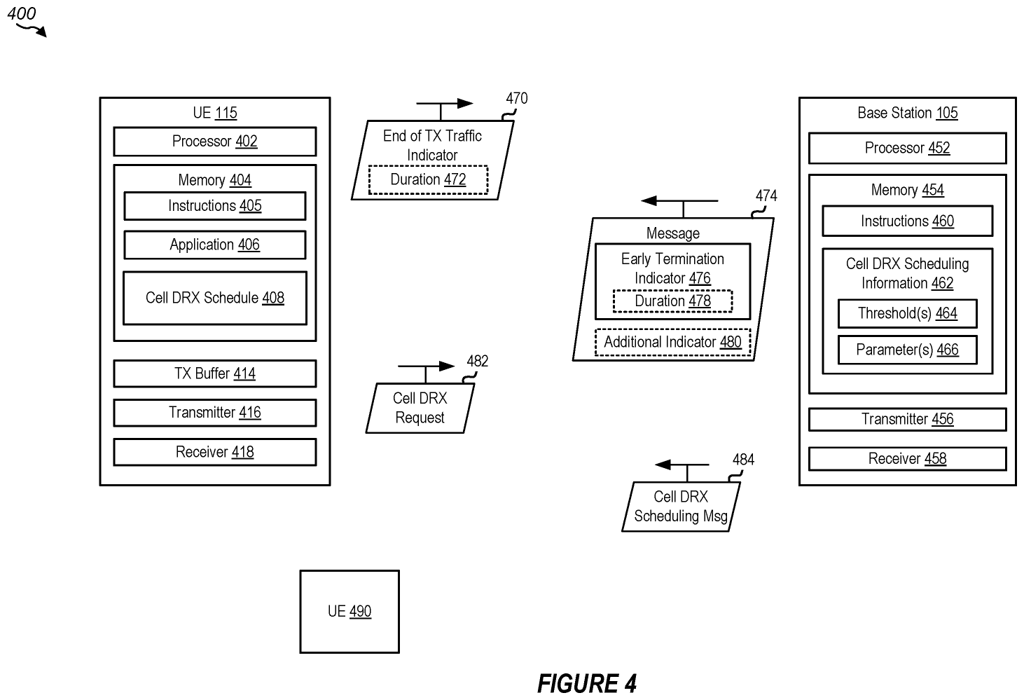

FIG. 4 is a block diagram of an example wireless communications system 400 that supports dynamic network-side cell DRX control and scheduling according to one or more aspects. In some examples, wireless communications system 400 may implement aspects of wireless network 100. Wireless communications system 400 includes UE 115, UE 490, and base station 105. Although two UEs (e.g., UE 115 and UE 490) and one base station 105 are illustrated, in some other implementations, wireless communications system 400 may generally include more than two UEs or a single UE, multiple base stations 105, or a combination thereof.

UE 115 may include a variety of components (such as structural, hardware components) used for carrying out one or more functions described herein. For example, these components may include one or more processors 402 (hereinafter referred to collectively as “processor 402”), one or more memory devices 404 (hereinafter referred to collectively as “memory 404”), a TX buffer 414, one or more transmitters 416 (hereinafter referred to collectively as “transmitter 416”), and one or more receivers 418 (hereinafter referred to collectively as “receiver 418”). In some implementations, UE 115 may include an interface (e.g., a communication interface) that includes transmitter 416, receiver 418, or a combination thereof. Processor 402 may be configured to execute instructions 405 stored in memory 404 to perform the operations described herein. In some implementations, processor 402 includes or corresponds to one or more of receive processor 258, transmit processor 264, and controller 280, and memory 404 includes or corresponds to memory 282.

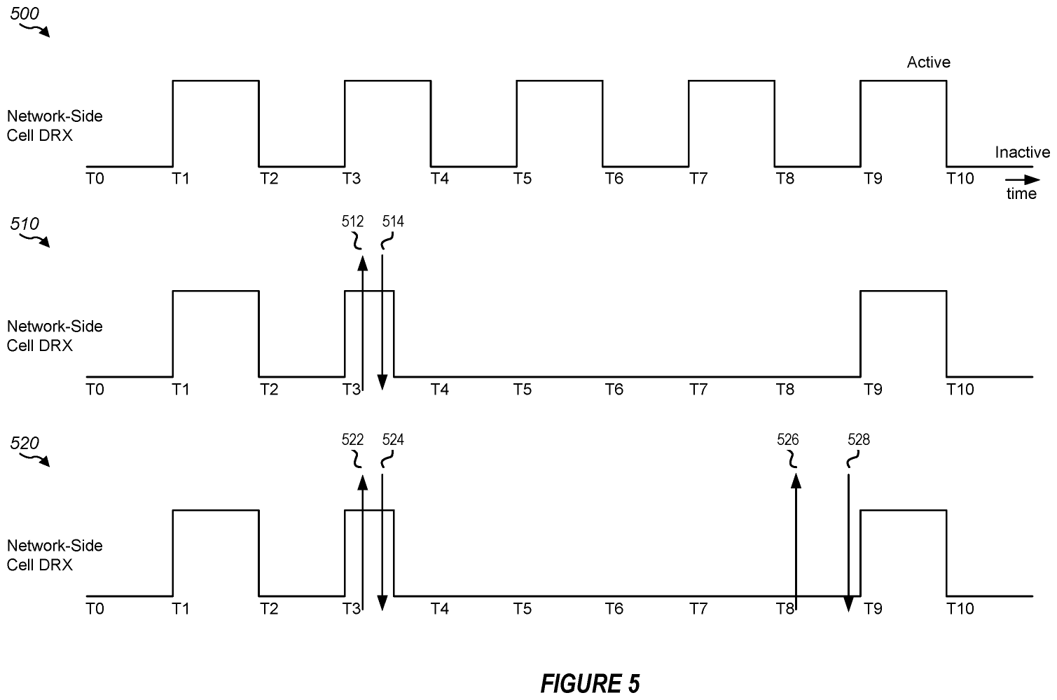

Memory 404 includes or is configured to store instructions 405, application 406, and cell DRX schedule 408. Application 406 (e.g., a “higher layer” application) may be executed by UE 115 to cause UE 115 to perform operations, including the generation of one or more data packets (e.g., TX traffic) for transmission UL transmission to base station 105. In some implementations, application 406 may include or correspond to a streaming media application, a virtual reality (VR) application, an augmented reality (AR) application, an extended reality (XR) application, a video game, or the like. Cell DRX schedule 408 indicates a schedule for network-side cell DRX active time periods, which may be based on a scheduling message or other signaling from base station 105. Illustrative examples of network-side cell DRX active time periods are described further below with reference to FIG. 5.

Transmitter 416 is configured to transmit reference signals, control information and data to one or more other devices, and receiver 418 is configured to receive references signals, synchronization signals, control information and data from one or more other devices. For example, transmitter 416 may transmit signaling, control information and data to, and receiver 418 may receive signaling, control information and data from, base station 105. In some implementations, transmitter 416 and receiver 418 may be integrated in one or more transceivers. Additionally or alternatively, transmitter 416 or receiver 418 may include or correspond to one or more components of UE 115 described with reference to FIG. 2.

In some implementations, UE 115 may include one or more antenna arrays. The one or more antenna arrays may be coupled to transmitter 416, receiver 418, or a communication interface. The antenna array may include multiple antenna elements configured to perform wireless communications with other devices, such as with base station 105. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of UE 115. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

TX buffer 414 may be configured to temporarily store (e.g., to buffer) one or more data packets prior to transmission by UE 115. For example, execution of application 406 may cause UE 115 to generate data packets for transmission as part of a TX burst to base station 105, and those data packets may be stored in TX buffer 414 until they are transmitted. In some implementations, when TX buffer 414 is empty, UE 115 may receive a zero buffer indication (e.g., a message, an exception, etc.).

UE 490 may include one or more components as described herein with reference to UE 115. In some implementations, UEs 115 and 490 are 5G-capable UEs, 6G-capable UEs, or a combination thereof.

Base station 105 may include a variety of components (such as structural, hardware components) used for carrying out one or more functions described herein. For example, these components may include one or more processors 452 (hereinafter referred to collectively as “processor 452”), one or more memory devices 454 (hereinafter referred to collectively as “memory 454”), one or more transmitters 456 (hereinafter referred to collectively as “transmitter 456”), and one or more receivers 458 (hereinafter referred to collectively as “receiver 458”). In some implementations, base station 105 may include an interface (e.g., a communication interface) that includes transmitter 456, receiver 458, or a combination thereof. Processor 452 may be configured to execute instructions 460 stored in memory 454 to perform the operations described herein. In some implementations, processor 452 includes or corresponds to one or more of receive processor 238, transmit processor 220, and controller 240, and memory 454 includes or corresponds to memory 242.

Memory 454 includes or is configured to store instructions 460 and cell DRX scheduling information 462. Cell DRX scheduling information 462 may indicate a schedule for network-side cell DRX (e.g., cell DRX schedule 408) that has been determined by base station 105, and optionally transmitted to one or more other devices. Additionally, cell DRX scheduling information 462 may include information used by base station 105 to determine the network-side cell DRX schedule and to determine whether to perform early termination of one or more network-side cell DRX active periods. For example, cell DRX scheduling may include one or more thresholds (referred to herein as “thresholds 464”), one or more parameters (referred to herein as “parameters 466”), other information, or a combination thereof. Thresholds 464 may include one or more thresholds used to perform comparisons as part of a process to determine whether to perform early termination on cell DRX active time periods. For example, thresholds 464 may include a threshold number of received end of TX traffic indicators, a threshold number of non-responsive UEs, a threshold latency parameter, a threshold priority value, other thresholds, or a combination thereof. Parameters 466 may include one or more parameters that are relevant to determining whether to perform early termination of cell DRX active time periods, as further explained below. For example, parameters 466 may include target latency values associated with communications to UEs within a serving cell of base station 105, priority values associated with active UEs within the serving cell, application identifiers or types associated with UEs with the serving cell, other parameters, or a combination thereof.

Transmitter 456 is configured to transmit reference signals, synchronization signals, control information and data to one or more other devices, and receiver 458 is configured to receive reference signals, control information and data from one or more other devices. For example, transmitter 456 may transmit signaling, control information and data to, and receiver 458 may receive signaling, control information and data from, UE 115. In some implementations, transmitter 456 and receiver 458 may be integrated in one or more transceivers. Additionally or alternatively, transmitter 456 or receiver 458 may include or correspond to one or more components of base station 105 described with reference to FIG. 2.

In some implementations, base station 105 may include one or more antenna arrays. The antenna array may include multiple antenna elements configured to perform wireless communications with other devices, such as with UE 115. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of base station 105. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

In some implementations, wireless communications system 400 implements a 5G NR network. For example, wireless communications system 400 may include multiple 5G-capable UEs 115 and multiple 5G-capable base stations 105, such as UEs and base stations configured to operate in accordance with a 5G NR network protocol such as that defined by the 3GPP. In some other implementations, wireless communications system 400 implements a 6G network.

During operation of wireless communications system 400, UE 115 may execute application 406, which may cause UE 115 to transmit data packets to base station 105 as one or more TX bursts. UE 115 may transmit the data packets (e.g., TX traffic) during network-side cell DRX active time periods indicated by cell DRX schedule 408, which may be transmitted by base station 105 periodically, when UE 115 joins a wireless network provided by base station 105, upon request of UE 115, or at another time. For example, cell DRX schedule 408 may indicate periodic scheduling of one or more cell DRX active cycles (e.g., time periods) interleaved with one or more cell DRX inactive cycles, and UE 115 may transmit the data packets as a TX burst during a cell DRX active cycle, in accordance with any other rules for network-side cell DRX active time periods. An example of such a schedule of cell DRX cycles is further described herein with reference to FIG. 5.

During the cell DRX active time period, UE 115 may determine that it no longer has, or will have, TX traffic (e.g., UL data) to transmit to base station 105 as part of the TX burst. For example, application 406 (e.g., a “higher layer” application) may provide an indicator of an end of TX traffic to UE 115, such as a message, an exception, a flag, or the like. In some implementations, application 406 may determine an end of TX traffic based on operations or processing performed by application 406. Additionally or alternatively, application 406 may manage TX buffer 414 and detect when TX buffer 414 is empty, or TX buffer 414 may be configured to provide a zero buffer indicator when empty. As such, in some implementations, UE 115 may receive the indicator after TX buffer 414 is empty. Alternatively, if application 406 is capable of determining when a current TX burst will end prior to the ending, UE 115 may receive the indicator prior to transmission of a last data packet of the current TX burst.

Responsive to the determination that TX traffic is ending, UE 115 may transmit end of TX traffic indicator 470 to base station 105. End of TX traffic indicator 470 may be included in signaling from UE 115 to base station 105, such as uplink control information (UCI) transmitted via a physical uplink control channel (PUCCH), a MAC-CE, a RRC message, another type of message, or a combination thereof. As particular, illustrative examples, end of TX traffic indicator 470 may include a zero buffer indicator or an end of burst indicator. For example, if UE 115 receives a zero buffer indicator when TX buffer 414 is empty, end of TX traffic indicator 470 may be the zero buffer indicator. As another example, end of TX traffic indicator 470 may be an end of TX burst indicator that is transmitted by UE 115 either prior to transmission of a last data packet of the current TX burst or after transmission of the data packet, depending on when an internal indicator is received from application 406.

In some implementations, end of TX traffic indicator 470 includes or is transmitted with duration 472 (e.g., a duration field). Duration 472 may indicate an expected duration during which UE 115 is expected to have no TX traffic (e.g., UL data) to communicate to base station 105, and duration 472 may be indicated in a variety of manners. For example, duration 472 may be a one or more bit field that indicates a particular amount of time (e.g., a particular number of ms), a particular number of scheduled cell DRX active cycles, or any other type of duration measurement or indication. In some other implementations, end of TX traffic indicator 470 may only apply to a current cell DRX active cycle (or other scheduled time period). In such implementations, duration 472 is not included, and UE 115 may be configured to transmit a respective end of TX traffic indicator 470 in each cell DRX active time period that UE 115 does not store TX traffic (e.g., UL data) to be transmitted to base station 105, regardless of whether such an indicator was transmitted during a previous cell DRX active time period.

Base station 105 may receive end of TX traffic indicator 470 and determine whether to early terminate (e.g., perform early termination of) one or more scheduled network-side cell DRX active time periods. In some implementations, UE 115 may be the only active UE within the serving cell of base station 105, or the only UE which base station 105 bases cell DRX scheduling decisions on. In such implementations, base station 105 may determine to perform early termination of scheduled cell DRX active time period(s) if base station 105 receives end of TX traffic indicator 470. If base station 105 does not receive end of TX traffic indicator 470, base station 105 may continue with the scheduled cell DRX active time period(s).

In some other implementations, additional UEs, such as UE 490, may be active within the serving cell of base station 105. In some such implementations, base station 105 may determine whether to perform early termination of scheduled cell DRX active time period(s) based on any end of TX traffic indicators received from the UEs, cell DRX scheduling information 462, or a combination thereof. To illustrate, base station 105 may determine whether to perform early termination based on a scheme that prioritizes transmit opportunities for all UEs within the serving cell, a scheme that prioritizes transmit opportunities of at least some (e.g., a threshold number of) UEs in the serving cell, a scheme that prioritizes transmit opportunities of UEs having lower target latencies or higher priorities, another type of scheme, or a combination thereof. As a non-limiting example, base station 105 may determine to perform early termination of scheduled cell DRX active time periods only if a corresponding end of TX traffic indicator 470 is received from each active UE in the serving cell. As another non-limiting example, base station 105 may determine to perform early termination of scheduled cell DRX active time periods if a corresponding end of TX traffic indicator 470 is received from a number of active UEs in the serving cell that satisfies a threshold number of thresholds 464. As another non-limiting example, base station 105 may determine whether to perform early termination of scheduled cell DRX active time periods based on parameters 466. To illustrate, base station 105 may determine to perform early termination of scheduled cell DRX active time periods if a corresponding end of TX traffic indicator 470 is received from each active UE (or a threshold number of active UEs) in the serving cell that is associated with a target latency or priority value of parameters 466 that satisfy a threshold value of thresholds 464. For example, if UEs 115 and 490 are associated with sufficiently low target latency values and other UEs in the serving cell are not, base station 105 may perform the early termination if end of TX traffic indicator 470 and a corresponding end of traffic indicator are received from UE 115 and UE 490, respectively.

Based on a determination to perform early termination on one or more scheduled cell DRX active time periods, base station 105 may transmit message 474 that includes early termination indicator 476. In some implementations, message 474 may be DCI transmitted via a PDCCH, either directly to UE 115 or to the group of UEs within the serving cell, such as UE 490. In some other implementations, message 474 may include or correspond to a MAC-CE, a RRC message, or another type of message that is capable of including early termination indicator 476. In some implementations in which message 474 is DCI, early termination indicator 476 may indicate termination of a current cell DRX active time period as well as one or more upcoming scheduled cell DRX active time periods. For example, early termination indicator 476 may indicate termination of a cell DRX active cycle during which message 474 is received by UE 115. In some other implementations, if message 474 is another type of message (e.g., MAC-CE, RRC, etc.), message 474 may be received during a cell DRX inactive time period and early termination indicator 476 may indicate termination of upcoming cell DRX active time periods.

In some implementations, early termination indicator 476 may include or correspond to a single bit or a single-bit field. For example, early termination indicator 476 may be a single bit in a header, or another location, of message 474, and early termination indicator 476 may have either a first value indicating early termination of the scheduled cell DRX active time periods or a second value indicating no early termination of the scheduled cell DRX active time periods. As a particular illustrative example, message 474 may be a group DCI message, and early termination indicator 476 may be a single bit of the group DCI message. In some other implementations, early termination indicator 476 may be multiple bits or a multi-bit field, and early termination indicator 476 may indicate more information than a binary indication of whether scheduled cell DRX active time periods are terminated early. As an example, early termination indicator 476 may include duration 478 (e.g., a duration field). Duration 478 may indicate a duration of time for which scheduled cell DRX active time periods are terminated or canceled. Duration 478 may be represented by one or more bits, and may indicate the duration of time in a variety of manners. For example, duration 478 may indicate a particular time period, such as in milliseconds or other units, that the termination of scheduled cell DRX active time periods applies. As another example, duration 478 may indicate a particular number of active cycles of periodic cell DRX indicated by cell DRX schedule 408. In some implementations, base station 105 may set duration 478 equal to duration 472 indicated by end of TX traffic indicator 470. Alternatively, UE 115 may be configured to interpret early termination indicator 476 as applying to duration 472 if UE 115 includes duration 472 with end of TX traffic indicator 470. In some other implementations, base station 105 may determine duration 478 based on durations indicated by multiple end of TX traffic indicators received from multiple UEs.

In some implementations, message 474 may include one or more additional early termination indicators, such as additional indicator 480. Additional indicator 480 may indicate termination of UE-side cell DRX active time period(s), also referred to as PDCCH skipping. To illustrate, similar cell DRX cycles may be scheduled including active time periods during which UEs in the serving cell (e.g., UE 115 and UE 490) actively monitor the wireless network for communications from base station 105, such as DCI transmitted via one or more PDCCHs. Additional indicator 480 may indicate termination of one or more scheduled UE-side cell DRX active time periods, which allows UE 115 and UE 490 to transition to respective low power operating modes (e.g., sleep modes) and conserve power during the terminated UE-side cell DRX active time periods. For example, to obtain both UE power saving gains and network entity power saving gains, base station 105 may perform early termination of network-side cell DRX and trigger PDCCH skipping (e.g., UE-side cell DRX) at the same time via a single message (e.g., message 474). Terminating the network-side cell DRX may enable base station 105 to skip reception of UL transmissions from UE 115 and UE 490, and terminating the UE-side cell DRX (e.g., the PDCCH skipping) may enable UE 115 and UE 490 to transition to low power operating modes with no DL reception from base station 105. In this manner, TX and RX (and termination thereof) are aligned at both base station 105 and UE 115 and UE 490. Additionally, or alternatively, additional indicator 480 may indicate other information, such as a type of message to use to request re-establishment of network-side cell DRX, additional instructions, other information, or a combination thereof.

After transmitting message 474, base station 105 may enter a low power operating mode (e.g., a sleep mode) during the terminated cell DRX active time periods. For example, the low power operating mode may include reducing power to one or more components of base station 105 to decrease power consumption, such as a receiver, a transceiver, a wireless interface, a processor or processing unit, other components, or a combination thereof, or otherwise going to sleep. Base station 105 may transition to the low power operating mode for a remainder of a scheduled network-side cell DRX active time indicated by early termination indicator 476, such as a remainder of a current network-side cell DRX active cycle, one or more upcoming cell DRX active cycles, a particular amount of time, or an indefinite amount of time (e.g., until re-establishment of network-side cell DRX), as described above. Although described as a low power operating mode and a sleep mode, during operation in this mode, base station 105 may still monitor for a particular type of message from UEs (e.g., cell DRX request messages) either periodically, at particular times, or otherwise, in a manner that reduces power consumption as compared to operating in an active operating mode and monitoring for UL transmission from UEs during cell DRX active cycles.

UE 115 may receive message 474, including early termination indicator 476, and UE 115 may refrain from transmitting data to base station 105 during one or more scheduled cell DRX active time periods based on early termination indicator 476. For example, UE 115 may power down transmitter 416, transition to a low power operating mode, or otherwise prohibit transmission of UL data to base station 105 during the terminated cell DRX active time periods. In some implementations, if new or additional data packets are generated during this time, the data packets may be buffered at TX buffer 414. UE 490 may perform similar operations based on receipt of message 474 (or a similar message if message 474 is not a group message). By providing message 474 with early termination indicator 476 to UEs 115 and 490, base station 105 enables UEs 115 and 490 to know that base station 105 will not be active during previously scheduled upcoming cell DRX active time periods, so UE 115 and UE 490 may avoid reduced performance associated with transmitting packets to base station 105 and expecting them to be received.

In some implementations, early termination indicator 476 includes duration 478, and UE 115 refrains from transmitting UL data to base station 105 for the indicated duration. For example, if duration 478 indicates an amount of time, such as a number of milliseconds, UE 115 may initialize a timer for the amount of time and may buffer any newly generated data packets in TX buffer 414 until expiration of the timer, instead of transmitting the data packets to base station 105 in one or more TX bursts during the amount of time. As another example, if duration 478 indicates a particular number of cycles, UE 115 may buffer any newly generated data packets in TX buffer 414 until a next non-terminated network-side cell DRX active cycle, instead of transmitting the data packets to base station 105 in one or more TX bursts during the terminated active cycles. In some other implementations, UE 115 may be configured to treat receipt of early termination indicator 476, even if duration 478 is not included, as termination of cell DRX active time periods for an amount of time corresponding to duration 472 included in or with end of TX traffic indicator 470.

In some implementations, early termination indicator 476 does not include duration 478, and early termination indicator 476 indicates termination of network-side cell DRX for an indefinite amount of time (e.g., until further notice/until network-side cell DRX is re-established). For example, if UE 115 receives early termination indicator 476 that does not include duration 478, UE 115 may refrain from transmitting UL data to base station 105 until until receipt of a scheduling message for a new scheduled network-side cell DRX active time. During this time, UE 115 may store any newly generated data packets in TX buffer 414 instead of transmitting the data packets to base station 105 as one or more TX bursts.

In some implementations in which early termination indicator 476 indicates an indefinite termination, UE 115 may generate new (e.g., additional) TX traffic, such as due to execution of application 406. In order to re-establish network-side cell DRX in order to be able to transmit the new TX traffic to base station 105, UE 115 may transmit cell DRX request 482 (e.g., a network-side cell DRX request) to base station 105. Cell DRX request 482 may include or correspond to a message that requests base station 105 to schedule cell DRX active time periods. For example, cell DRX request 482 may include or correspond to a scheduling request (SR) or a cell wake-up signal (CWUS). In other implementations, cell DRX request 482 may be another type of message or signaling, such as a MAC-CE, an RRC message, or another type of message.

In response to receiving cell DRX request 482, base station 105 may transition from the low power operating mode to the active operating mode and transmit cell DRX scheduling message 484 to UE 115 and UE 490 (e.g., to active UEs within the serving cell). Cell DRX scheduling message 484 may indicate a schedule for upcoming network-side cell DRX active time periods, similar to cell DRX schedule 408. In some implementations, cell DRX scheduling message 484 may schedule new cell DRX active time periods according to one or more parameters of cell DRX schedule 408, such as the same period, frequency, etc. Alternatively, cell DRX scheduling message 484 may indicate a new schedule that does not share parameters in common with cell DRX schedule 408.

After identifying a next network-side cell DRX active time period (e.g., identifying an end of duration 478 or identifying a cell DRX active time period indicated by cell DRX scheduling message 484), UE 115 may transmit any new or additional data packets stored in TX buffer 414 to base station 105 as one or more TX bursts. For example, UE 115 may comply with any other cell DRX rules to perform transmission of one or more data packets from TX buffer 414 to base station 105 in one or more TX bursts. In this manner, base station 105 may conserve power by entering the low power operating mode during time periods when UEs do not expect to transmit TX traffic and returning to the active operating mode when additional TX traffic is expected, thereby reducing or avoiding an impact on the latency and throughput of the UEs.

As described with reference to FIG. 4, the present disclosure provides techniques for supporting dynamic network-side cell DRX control and scheduling. The techniques described enable a network entity, such as base station 105, to dynamically determine whether to terminate scheduled network-side cell DRX active time period(s), thereby enabling base station 105 to enter a low power operating mode (e.g., a sleep mode) and conserve power. The determination may be based on information from one or more UEs within a serving cell, such as end of TX traffic indicator 470, that indicates that UE 115 will not be transmitting during the scheduled network-side cell DRX active time period(s). Because UE 115 will not be transmitting during these active times, base station 105 may enter the sleep mode with minimal to no impact on latency and throughput at UE 115 (or at UE 115 and UE 490 in implementations in which base station 105 determines whether to terminate network-side cell DRX active times based on multiple UEs). As such, the techniques with reference to FIG. 4 enable improved communications, including efficient resource utilization (e.g., less interference with other devices during terminate network-side cell DRX active time periods) and reduced power consumption at base station 105. Additionally, in some implementations, UE 115 may be enabled to request rescheduling of cell DRX active time periods if additional TX traffic is generated by transmitting cell DRX request 482, thereby providing for UEs or applications with low latency requirements the ability to quickly re-instate network-side cell DRX.

FIG. 5 shows multiple examples of network-side cell DRX active time periods according to one or more aspects. The illustrative examples shown in FIG. 5 include a first example 500 of network-side cell DRX active time periods, a second example 510 of network-side cell DRX active time periods, and a third example 520 of network-side cell DRX active time periods. The examples 500, 510, 520 of FIG. 5 are provided for illustration and in other implementations, active time periods for network-side cell DRX may be different than shown in FIG. 5.

First example 500 is an example of a statically scheduled network-side cell DRX cycle that is not terminated early. To illustrate, a base station (e.g., base station 105 of FIGS. 1-4) is periodically active and monitoring for wireless communications from one or more UEs (e.g., UE 115 of FIGS. 1-4) during active time periods that are separated by periodic inactivity time periods during which the base station does not monitor for wireless communications from UEs (and may perform other operations). The active time periods and inactive time periods may be scheduled to follow a cycle as shown in FIG. 5. For example, the base station may actively monitor for wireless communications within the cell during active time periods T1 to T2, T3 to T4, T5 to T6, T7 to T8, and T9 to T10, and the base station may be inactive with respect to monitoring for discontinuous UL communications from the UEs during inactive time periods T0 to T1, T2 to T3, T4 to T5, T6 to T7, and T8 to T9. Although the base station is not actively monitoring for wireless communications during the inactive time periods, the inactive time periods may be too short for the base station benefit from transitioning into a low power operating mode (e.g., a sleep mode) to conserve power.

Second example 510 is an example of a dynamically scheduled network-side cell DRX cycle that is terminated early for a particular time period. To illustrate, the base station may receive an end of TX traffic indicator 512 (e.g., end of TX traffic indicator 470 of FIG. 4) from a UE and, based on a determination to terminate the network-side cell DRX early, the base station may transmit an early termination indicator 514 (e.g., early termination indicator 476 of FIG. 4) associated with the network-side cell DRX. The determination to perform early termination may be based on receipt of end of TX traffic indicator 512 (e.g., if a single UE is within the serving cell of the base station) or based on receipt of end of TX traffic indicator 512 and additional parameters, such as whether a threshold number of end of TX traffic indicators have been received, whether end of TX traffic indicators have been received from all high priority or low latency UEs, or the like, as described above with reference to FIG. 4. After transmitting early termination indicator 514, the base station may start an inactive time period early, prior to time T4, and enter a low power operating mode (e.g., a sleep mode) to conserve power. Although delays are shown in FIG. 5 between receipt of end of TX traffic indicator 512 and transmission of early termination indicator 514, and between transmission of early termination indicator 514 and termination of the active time period, in other implementations, one or both of the delays may be shorter or longer, or one or both of the delays may not exist. In second example 510, termination of the network-side cell DRX cycle is for a particular time period. For example, end of TX traffic indicator 512 may include or be transmitted with a duration field (e.g., duration 472 of FIG. 4), and early termination indicator 514 may include or be transmitted with a duration field (e.g., duration 478 of FIG. 4) that indicates a duration of the termination of the network-side cell DRX cycle. Alternatively, UEs may be configured such that, by reporting a duration field with an end of TX traffic indicator, the UE automatically determines that any termination of the network-side cell DRX cycle will be for the amount indicated in the duration field with the end of TX traffic indicator (e.g., early termination indicator 514 may not include a duration field). The duration may be indicated as a number of network-side cell DRX active cycles, an amount of time, or any other manner. As an illustrative, non-limiting example shown in FIG. 5, the duration may be two active cycles and a remainder of a current active cycle (e.g., the next active cycle may begin at time T9).

Third example 520 is an example of a dynamically scheduled network-side cell DRX cycle that is terminated early for an indefinite time period. To illustrate, the base station may receive an end of TX traffic indicator 522 (e.g., end of TX traffic indicator 470 of FIG. 4) from a UE and, based on a determination to terminate the network-side cell DRX early, the base station may transmit an early termination indicator 524 (e.g., early termination indicator 476 of FIG. 4) associated with the network-side cell DRX. The determination to perform early termination may be based on receipt of end of TX traffic indicator 522 and, optionally, additional parameters, as described above. After transmitting early termination indicator 524, the base station may start an inactive time period early, prior to time T4, and enter a low power operating mode (e.g., a sleep mode) to conserve power. In third example 520, termination of the network-side cell DRX cycle is for an indefinite time period. To illustrate, the network-side cell DRX active time period(s) may be terminated until the base station schedules a new network-side cell DRX cycle, such as based on receipt of a request from a UE. For example, when the UE determines that there is additional data packets for UL transmission to the base station, the UE may transmit a cell DRX request 526 (e.g., cell DRX request 482 of FIG. 4) and, upon determining to reactive network-side cell DRX, the base station may transmit a cell DRX scheduling message 528 (e.g., cell DRX scheduling message 484 of FIG. 4) to indicate a schedule for a new network-side cell DRX cycle. As an illustrative, non-limiting example shown in FIG. 5, the new schedule for network-side cell DRX cycles may align with the schedule for the terminated network-side cell DRX cycles, such that the next active cycle begins at time T9. Although delays are shown in FIG. 5 between receipt of cell DRX request 526 and transmission of cell DRX scheduling message 528, and between transmission of cell DRX scheduling message 528 and initiation of the active time period, in other implementations, one or both of the delays may be shorter or longer, or one or both of the delays may not exist.

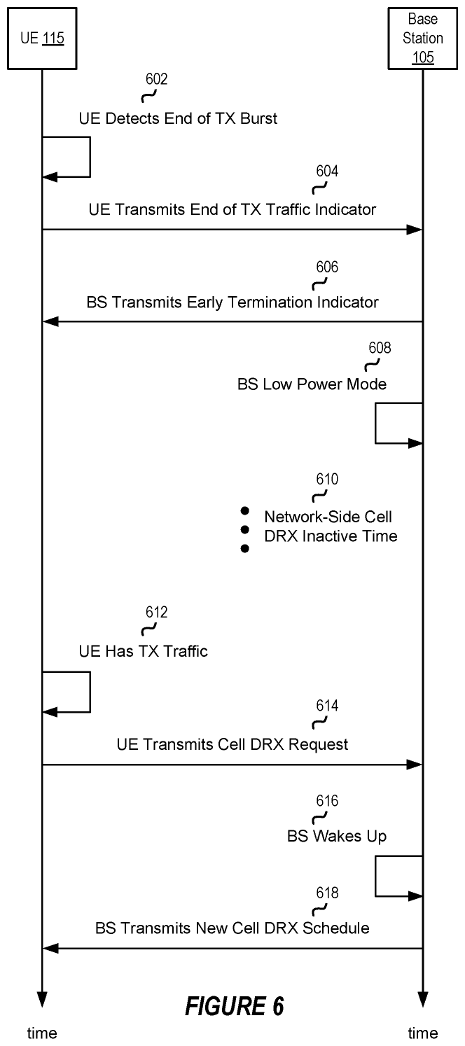

FIG. 6 is a ladder diagram illustrating an example process 600 that supports dynamic network-side cell DRX control and scheduling according to one or more aspects. Operations of process 600 may be performed by UE 115 and base station 105 as shown in FIG. 6, which may include or correspond to UE 115 of FIGS. 1-4 and base station 105 of FIGS. 1-4, respectively.

UE 115 may detect an end of a current TX burst, at 602. For example, UE 115 may receive an indication from a higher layer application (e.g., application 406 of FIG. 4) that a current TX burst has or will be ending (e.g., TX buffer 414 of FIG. 4 may be empty or application 406 may determine that a last data packet of a current communication has been generated). UE 115 may transmit an end of TX traffic indicator to base station 105 based on the detection, at 604. For example, UE 115 may transmit end of TX traffic indicator 470 of FIG. 4 to base station 105 based on the indication from the application.

Base station 105 may transmit an early termination indicator to UE 115, at 606. For example, base station 105 may determine to perform early termination on one or more scheduled network-side cell DRX active time periods based on receipt of the end of TX traffic indicator from UE 115 (and optionally based on receipt of other end of TX traffic indicators from other UEs within a serving cell, other parameters (e.g., cell DRX scheduling information 462 of FIG. 4), or a combination thereof). In response to determining to perform the early termination, base station 105 may transmit message 474 of FIG. 4, including early termination indicator 476, to UE 115.

Base station 105 may transition to a low power operating mode (e.g., a sleep mode), at 608. Base station 105 may remain in the low power operating mode during network-side cell DRX inactive time, at 610. In some implementations, the network-side cell DRX inactive time is for a particular duration, such as a particular time period, a particular amount of DRX active cycles, or the like. In some other implementations, the network-side cell DRX inactive time is for an indefinite time period, until a UE requests to re-establish network-side cell DRX.

In some such implementations, UE 115 may determine that additional TX traffic is ready to be transmitted, at 612. For example, the application being executed by UE 115 may generate one or more data packets for UL transmission and such data packets may be temporarily stored in the buffer. Based on having the additional TX traffic for transmission, UE 115 may transmit a cell DRX request to base station 105, at 614. For example, UE 115 may transmit cell DRX request 482 of FIG. 4 to base station 105. Based on receiving the cell DRX request, base station 105 may wake up (e.g., transition to an active operating mode), at 616, and base station 105 may transmit a new cell DRX schedule to UE 115, at 618. For example, base station 105 may determine to re-establish network-side cell DRX based on receipt of the cell DRX request (and optionally other information), and base station 105 may transmit cell DRX scheduling message 484 of FIG. 4 to UE 115. UE 115 may use the received new cell DRX schedule to identify a next network-side cell DRX active time period for transmitting the additional TX traffic.

FIG. 7 is a flow diagram illustrating an example process 700 that supports dynamic network-side cell DRX control and scheduling according to one or more aspects. Operations of process 700 may be performed by a UE, such as UE 115 described above with reference to FIGS. 1-4 and 6 or a UE described with reference to FIG. 8. For example, example operations (also referred to as “blocks”) of process 700 may enable UE 115 to support dynamic network-side cell DRX control and scheduling.

In block 702, the UE transmits an end of TX traffic indicator. For example, the end of TX traffic indicator may include or correspond to end of TX traffic indicator 470 of FIG. 4.

In block 704, the UE receives an early termination indicator associated with a scheduled network-side cell DRX active time. For example, the early termination indicator may include or correspond to early termination indicator 476 of FIG. 4.

In block 706, the UE refrains from transmitting data traffic during at least a remainder of the scheduled network-side cell DRX active time. For example, UE 115 of FIG. 4 may refrain from transmitting UL data to base station 105 for at least a remainder of the scheduled network-side cell DRX active time based on receipt of early termination indicator 476.

In some implementations, the scheduled network-side cell DRX active time includes a first cycle of multiple active time cycles, and the early termination indicator indicates termination of a particular number of cycles of the multiple active time cycles. For example, the early termination indicator may indicate termination of two active cycles, as described with reference to second example 510 of FIG. 5. Alternatively, the early termination indicator may indicate termination of network-side cell DRX active time for a particular time period. For example, the early termination indicator may indicate termination of cell DRX active time periods for a particular number of milliseconds (or other time units). Alternatively, refraining from transmitting the data traffic during at least the remainder of the scheduled network-side cell DRX active time may include refraining from transmitting the data traffic until receipt of a scheduling message for a new scheduled network-side cell DRX active time. For example, the scheduling message may include or correspond to cell DRX scheduling message 484 of FIG. 4.

In some implementations, process 700 further includes transmitting a network-side cell DRX request based on detection of buffered TX data packets and receiving a scheduling message for a new scheduled network-side cell DRX active time based on transmission of the network-side cell DRX request. For example, the network-side cell DRX request may include or correspond to cell DRX request 482 of FIG. 4, and the scheduling message may include or correspond to Cell DRX scheduling message 484 of FIG. 4. In some such implementations, the network-side cell DRX request includes or corresponds to a SR or a CWUS.

In some implementations, process 700 also includes receiving the end of TX indicator from a higher layer application executed at the UE. For example, the application may include or correspond to application 406 of FIG. 4. Additionally or alternatively, the end of TX traffic indicator may include or correspond to a zero buffer indicator transmitted after a TX buffer is empty. Alternatively, the end of TX traffic indicator may include or correspond an end of TX burst indicator transmitted prior to transmission of a last data packet of a corresponding TX burst.

In some implementations, the early termination indicator is included in a MAC-CE or a RRC message. For example, message 474 of FIG. 4 may include or correspond to a MAC-CE or RRC message. In some other implementations, the early termination indicator is included in a DCI message. For example, message 474 of FIG. 4 may include or correspond to DCI. In some such implementations, the DCI message also includes an early termination indicator associated with a scheduled UE-side cell DRX active time. For example, the early termination indicator associated with the scheduled UE-side cell DRX active time may include or correspond to additional indicator 480 of FIG. 4. Additionally or alternatively, the DCI message may be a group DCI message, and the early termination indicator may include a single bit of the group DCI message. For example, message 474 of FIG. 4 may include or correspond to a group DCI message, and early termination indicator 476 may include or correspond to a single bit.

FIG. 8 is a block diagram of an example UE 800 that supports dynamic network-side cell DRX control and scheduling according to one or more aspects. UE 800 may be configured to perform operations, including the blocks of a process described with reference to FIG. 6. In some implementations, UE 800 includes the structure, hardware, and components shown and described with reference to UE 115 of FIGS. 1-4 and 6. For example, UE 800 includes controller 280, which operates to execute logic or computer instructions stored in memory 282, as well as controlling the components of UE 800 that provide the features and functionality of UE 800. UE 800, under control of controller 280, transmits and receives signals via wireless radios 801a-r and antennas 252a-r. Wireless radios 801a-r include various components and hardware, as illustrated in FIG. 2 for UE 115, including modulator and demodulators 254a-r, MIMO detector 256, receive processor 258, transmit processor 264, and TX MIMO processor 266.

As shown, memory 282 may include an application 802, cell DRX schedule 803, and communication logic 804. Application 802 may include or correspond to application 406 of FIG. 4. Cell DRX schedule 803 may include or correspond to cell DRX schedule 408 of FIG. 4. Communication logic 804 may be configured to enable communication between UE 800 and one or more other devices. UE 800 may receive signals from or transmit signals to one or more network entities, such as base station 105 of FIGS. 1-4 and 6 or a base station as illustrated in FIG. 10.

FIG. 9 is a flow diagram illustrating an example process 900 that supports dynamic network-side cell DRX control and scheduling according to one or more aspects. Operations of process 900 may be performed by a base station, such as base station 105 described above with reference to FIGS. 1-4 and 6 or a base station as described above with reference to FIG. 10. For example, example operations of process 900 may enable base station 105 to support dynamic network-side cell DRX control and scheduling.

At block 902, the base station receives one or more end of TX traffic indicators. For example, the one or more end of TX traffic indicators may include or correspond to end of TX traffic indicator 470 of FIG. 4.

At block 904, the base station transmits an early termination indicator associated with a scheduled network-side cell DRX active time based on receipt of the one or more end of TX traffic indicators. For example, the early termination indicator may include or correspond to early termination indicator 476 of FIG. 4.

In some implementations, process 900 further includes transitioning to a low power mode during at least a remainder of the scheduled network-side cell DRX active time. For example, base station 105 of FIG. 4 may transition to a low power operating mode (e.g., a sleep mode) for the terminated cell DRX active time.

In some implementations, the early termination indicator indicates termination of network-side cell DRX active time for a particular time period. For example, the early termination indicator may indicate termination of cell DRX active time periods for a particular number of milliseconds (or other time units). In some other implementations, the scheduled network-side cell DRX active time may include a first cycle of multiple active time cycles, and the early termination indicator may indicate termination of a particular number of cycles of the multiple active time cycles. For example, the early termination indicator may indicate termination of two active cycles, as described with reference to second example 510 of FIG. 5. In some such implementations, process 900 also includes, for each cycle of the multiple active time cycles, determining whether to terminate scheduled network-side cell DRX active time for the cycle based on whether a corresponding end of TX traffic indicator has been received. For example, base station 105 of FIG. 4 may determine whether to cancel each active cycle based on whether it has received end of TX traffic indicator 470 from UE 115 for each cycle, as described above with reference to FIG. 4.

In some implementations, process 900 further includes receiving a network-side cell DRX request and transmitting a scheduling message for a new scheduled network-side cell DRX active time based on receipt of the network-side cell DRX request. For example, the network-side cell DRX request may include or correspond to cell DRX request 482 of FIG. 4, and the scheduling message may include or correspond to Cell DRX scheduling message 484 of FIG. 4. In some such implementations, the network-side cell DRX request includes or corresponds to a SR or a CWUS.

In some implementations, the one or more end of TX traffic indicators include or correspond to zero buffer indicators received after receipt of a last data packet of a corresponding TX traffic burst. In some other implementations, the one or more end of TX traffic indicators include or correspond to end of TX burst indicators received prior to receipt of a last data packet of a corresponding TX traffic burst.

In some implementations, the early termination indicator is included in a MAC-CE or a RRC message. For example, message 474 of FIG. 4 may include or correspond to a MAC-CE or RRC message. In some other implementations, the early termination indicator is included in a DCI message. For example, message 474 of FIG. 4 may include or correspond to DCI. In some such implementations, the DCI message also includes an early termination indicator associated with a scheduled UE-side cell DRX active time. For example, the early termination indicator associated with the scheduled UE-side cell DRX active time may include or correspond to additional indicator 480 of FIG. 4. Additionally or alternatively, the DCI message may be a group DCI message, and the early termination indicator may include a single bit of the group DCI message. For example, message 474 of FIG. 4 may include or correspond to a group DCI message, and early termination indicator 476 may include or correspond to a single bit.

In some implementations, the transmission of the early termination indicator is based on receipt of a threshold number of end of TX traffic indicators. For example, the threshold number may include or correspond to thresholds 464 of FIG. 4. Additionally or alternatively, the transmission of the early termination indicator may be based on a latency parameter associated with a UE from which the early termination indicator is received and latency parameters associated with one or more other UEs within a serving cell of the base station. For example, the latency parameter and the latency parameters may include or correspond to parameters 466 of FIG. 4.

FIG. 10 is a block diagram of an example base station 1000 that supports dynamic network-side cell DRX control and scheduling according to one or more aspects. Base station 1000 may be configured to perform operations, including the blocks of process 900 described with reference to FIG. 9. In some implementations, base station 1000 includes the structure, hardware, and components shown and described with reference to base station 105 of FIGS. 1-4 and 6. For example, base station 1000 may include controller 240, which operates to execute logic or computer instructions stored in memory 242, as well as controlling the components of base station 1000 that provide the features and functionality of base station 1000. Base station 1000, under control of controller 240, transmits and receives signals via wireless radios 1001a-t and antennas 234a-t. Wireless radios 1001a-t include various components and hardware, as illustrated in FIG. 2 for base station 105, including modulator and demodulators 232a-t, transmit processor 220, TX MIMO processor 230, MIMO detector 236, and receive processor 238.

As shown, the memory 242 may include cell DRX scheduling information 1002 and communication logic 1003. Cell DRX scheduling information 1002 may include or correspond to cell DRX scheduling information 462 of FIG. 4. Communication logic 1003 may be configured to enable communication between base station 1000 and one or more other devices. Base station 1000 may receive signals from or transmit signals to one or more UEs, such as UE 115 of FIGS. 1-4 and 6 or UE 800 of FIG. 8.

It is noted that one or more blocks (or operations) described with reference to FIGS. 7 and 9 may be combined with one or more blocks (or operations) described with reference to another of the figures. For example, one or more blocks (or operations) of FIG. 7 may be combined with one or more blocks (or operations) of FIG. 9. As another example, one or more blocks associated with FIG. 9 may be combined with one or more blocks associated with FIG. 7. As another example, one or more blocks associated with FIG. 7 or 9 may be combined with one or more blocks (or operations) associated with FIGS. 1-6. Additionally, or alternatively, one or more operations described above with reference to FIGS. 1-6 may be combined with one or more operations described with reference to FIG. 8 or 10.

In one or more aspects, techniques for supporting dynamic network-side cell DRX control and scheduling may include additional aspects, such as any single aspect or any combination of aspects described below or in connection with one or more other processes or devices described elsewhere herein. In a first aspect, techniques for supporting dynamic network-side cell DRX control and scheduling may include transmitting a TX traffic indicator. The techniques may also include receiving an early termination indicator associated with a scheduled network-side cell DRX active time. The techniques may further include refraining from transmitting data traffic during at least a remainder of the scheduled network-side cell DRX active time. In some examples, the techniques in the first aspect may be implemented in a method or process. In some other examples, the techniques of the first aspect may be implemented in a wireless communication device, which may include a UE or a component of a UE. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.

In a second aspect, in combination with the first aspect, the scheduled network-side cell DRX active time includes a first cycle of multiple active time cycles. The early termination indicator indicates termination of a particular number of cycles of the multiple active time cycles.

In a third aspect, in combination with the first aspect, the early termination indicator indicates termination of network-side cell DRX active time for a particular time period.

In a fourth aspect, in combination with the first aspect, refraining from transmitting the data traffic during at least the remainder of the scheduled network-side cell DRX active time includes refraining from transmitting the data traffic until receipt of a scheduling message for a new scheduled network-side cell DRX active time.

In a fifth aspect, in combination with one or more of the first aspect through the fourth aspect, the techniques further include transmitting a network-side cell DRX request based on detection of buffered TX data packets and receiving a scheduling message for a new scheduled network-side cell DRX active time based on transmission of the network-side cell DRX request.

In a sixth aspect, in combination with the fifth aspect, the network-side cell DRX request includes a SR or a CWUS.

In a seventh aspect, in combination with one or more of the first aspect through the sixth aspect, the techniques further include receiving the end of TX indicator from a higher layer application executed at the UE.

In an eighth aspect, in combination with one or more of the first aspect through the seventh aspect, the end of TX traffic indicator includes a zero buffer indicator transmitted after a TX buffer is empty.

In a ninth aspect, in combination with one or more of the first aspect through the seventh aspect, the end of TX traffic indicator includes an end of TX burst indicator transmitted prior to transmission of a last data packet of a corresponding TX burst.

In a tenth aspect, in combination with one or more of the first aspect through the ninth aspect, the early termination indicator is included in a DCI message.

In an eleventh aspect, in combination with the tenth aspect, the DCI message further includes an early termination indicator associated with a scheduled UE-side cell DRX active time.

In a twelfth aspect, in combination with the tenth aspect or the eleventh aspect, the DCI message is a group DCI message. The early termination indicator includes a single bit of the group DCI message.

In a thirteenth aspect, in combination with one or more of the first aspect through the ninth aspect, the early termination indicator is included in a MAC-CE or a RRC message.

In one or more aspects, techniques for supporting dynamic network-side cell DRX control and scheduling may include additional aspects, such as any single aspect or any combination of aspects described below or in connection with one or more other processes or devices described elsewhere herein. In a fourteenth aspect, techniques for supporting dynamic network-side cell DRX control and scheduling may include receiving one or more end of TX traffic indicators. The techniques may further include transmitting an early termination indicator associated with a scheduled network-side cell DRX active time based on receipt of the one or more end of TX traffic indicators. In some examples, the techniques in the fourteenth aspect may be implemented in a method or process. In some other examples, the techniques of the fourteenth aspect may be implemented in a wireless communication device, such as network entity, which may include a base station or a component of a base station. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.

In a fifteenth aspect, in combination with the fourteenth aspect, the techniques further include transitioning to a low power mode during at least a remainder of the scheduled network-side cell DRX active time.

In a sixteenth aspect, in combination with the fourteenth aspect or the fifteenth aspect, the scheduled network-side cell DRX active time includes a first cycle of multiple active time cycles. The early termination indicator indicates termination of a particular number of cycles of the multiple active time cycles.

In a seventeenth aspect, in combination with the sixteenth aspect, the techniques further include, for each cycle of the multiple active time cycles, determining whether to terminate scheduled network-side cell DRX active time for the cycle based on whether a corresponding end of TX traffic indicator has been received.

In an eighteenth aspect, in combination with one or more of the fourteenth aspect through the fifteenth aspect, the early termination indicator indicates termination of network-side cell DRX active time for a particular time period.

In a nineteenth aspect, in combination with one or more of the fourteenth aspect through the eighteenth aspect, the techniques further include receiving a network-side cell DRX request and transmitting a scheduling message for a new scheduled network-side cell DRX active time based on receipt of the network-side cell DRX request.

In a twentieth aspect, in combination with the nineteenth aspect, the network-side cell DRX request includes a SR or a CWUS.

In a twenty-first aspect, in combination with one or more of the fourteenth aspect through the twentieth aspect, the one or more end of TX traffic indicators include zero buffer indicators received after receipt of a last data packet of a corresponding TX traffic burst.

In a twenty-second aspect, in combination with one or more of the fourteenth aspect through the twentieth aspect, the one or more end of TX traffic indicators include end of TX burst indicators received prior to receipt of a last data packet of a corresponding TX traffic burst.

In a twenty-third aspect, in combination with one or more of the fourteenth aspect through the twenty-second aspect, the early termination indicator is included in a DCI message.

In a twenty-fourth aspect, in combination with the twenty-third aspect, the DCI message further includes an early termination indicator associated with a scheduled UE-side cell DRX active time.

In a twenty-fifth aspect, in combination with one or more of the twenty-third aspect through the twenty-fourth aspect, the DCI message is a group DCI message. The early termination indicator includes a single bit of the group DCI message.

In a twenty-sixth aspect, in combination with the fourteenth aspect through the twenty-second aspect, the early termination indicator is included in a MAC-CE or a RRC message.

In a twenty-seventh aspect, in combination with one or more of the fourteenth aspect through the twenty-sixth aspect, the transmission of the early termination indicator is based on receipt of a threshold number of end of TX traffic indicators.

In a twenty-eighth aspect, in combination with one or more of the fourteenth aspect through the twenty-sixth aspect, the transmission of the early termination indicator is based on a latency parameter associated with a UE from which the early termination indicator is received and latency parameters associated with one or more other UEs within a serving cell of the network entity.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-10 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication performed by a user equipment (UE), the method comprising:
transmitting an end of transmit (TX) traffic indicator;
receiving an early termination indicator associated with a scheduled network-side cell discontinuous reception (DRX) active time; and
refraining from transmitting data traffic during at least a remainder of the scheduled network-side cell DRX active time.

2. The method of claim 1, wherein the scheduled network-side cell DRX active time comprises a first cycle of multiple active time cycles, and wherein the early termination indicator indicates termination of a particular number of cycles of the multiple active time cycles.

3. The method of claim 1, wherein the early termination indicator indicates termination of network-side cell DRX active time for a particular time period.

4. The method of claim 1, wherein refraining from transmitting the data traffic during at least the remainder of the scheduled network-side cell DRX active time comprises refraining from transmitting the data traffic until receipt of a scheduling message for a new scheduled network-side cell DRX active time.

5. The method of claim 1, further comprising:
transmitting a network-side cell DRX request based on detection of buffered TX data packets; and
receiving a scheduling message for a new scheduled network-side cell DRX active time based on transmission of the network-side cell DRX request.

6. The method of claim 5, wherein the network-side cell DRX request comprises a scheduling request (SR) or a cell wake-up signal (CWUS).

7. The method of claim 1, further comprising receiving the end of TX indicator from a higher layer application executed at the UE.

8. A user equipment (UE) comprising:
a memory storing processor-readable code; and
at least one processor coupled to the memory, the at least one processor configured to execute the processor-readable code to cause the at least one processor to:
initiate transmission of an end of transmit (TX) traffic indicator;
receive an early termination indicator associated with a scheduled network-side cell discontinuous reception (DRX) active time; and
refrain from transmitting data traffic during at least a remainder of the scheduled network-side cell DRX active time.

9. The UE of claim 8, wherein the end of TX traffic indicator comprises a zero buffer indicator transmitted after a TX buffer is empty.

10. The UE of claim 8, wherein the end of TX traffic indicator comprises an end of TX burst indicator transmitted prior to transmission of a last data packet of a corresponding TX burst.

11. The UE of claim 8, wherein the early termination indicator is included in a downlink control information (DCI) message.

12. The UE of claim 11, wherein the DCI message further includes an early termination indicator associated with a scheduled UE-side cell DRX active time.

13. The UE of claim 11, wherein the DCI message is a group DCI message, and wherein the early termination indicator comprises a single bit of the group DCI message.

14. The UE of claim 8, wherein the early termination indicator is included in a medium access control (MAC) control element (MAC-CE) or a radio resource control (RRC) message.

15. A method of wireless communication performed by a network entity, the method comprising:
receiving one or more end of transmit (TX) traffic indicators; and
transmitting an early termination indicator associated with a scheduled network-side cell discontinuous reception (DRX) active time based on receipt of the one or more end of TX traffic indicators.

16. The method of claim 15, further comprising transitioning to a low power mode during at least a remainder of the scheduled network-side cell DRX active time.

17. The method of claim 15, wherein the scheduled network-side cell DRX active time comprises a first cycle of multiple active time cycles, and wherein the early termination indicator indicates termination of a particular number of cycles of the multiple active time cycles.

18. The method of claim 17, further comprising, for each cycle of the multiple active time cycles, determining whether to terminate scheduled network-side cell DRX active time for the cycle based on whether a corresponding end of TX traffic indicator has been received.

19. The method of claim 15, wherein the early termination indicator indicates termination of network-side cell DRX active time for a particular time period.

20. The method of claim 15, further comprising:
receiving a network-side cell DRX request; and
transmitting a scheduling message for a new scheduled network-side cell DRX active time based on receipt of the network-side cell DRX request.

21. The method of claim 20, wherein the network-side cell DRX request comprises a scheduling request (SR) or a cell wake-up signal (CWUS).

22. A network entity comprising:
a memory storing processor-readable code; and
at least one processor coupled to the memory, the at least one processor configured to execute the processor-readable code to cause the at least one processor to:
receive one or more end of transmit (TX) traffic indicators; and
initiate transmission of an early termination indicator associated with a scheduled network-side cell discontinuous reception (DRX) active time based on receipt of the one or more end of TX traffic indicators.

23. The network entity of claim 22, wherein the one or more end of TX traffic indicators comprise zero buffer indicators received after receipt of a last data packet of a corresponding TX traffic burst.

24. The network entity of claim 22, wherein the one or more end of TX traffic indicators comprise end of TX burst indicators received prior to receipt of a last data packet of a corresponding TX traffic burst.

25. The network entity of claim 22, wherein the early termination indicator is included in a downlink control information (DCI) message.

26. The network entity of claim 25, wherein the DCI message further includes an early termination indicator associated with a scheduled UE-side cell DRX active time.

27. The network entity of claim 25, wherein the DCI message is a group DCI message, and wherein the early termination indicator comprises a single bit of the group DCI message.

28. The network entity of claim 22, wherein the early termination indicator is included in a medium access control (MAC) control element (MAC-CE) or a radio resource control (RRC) message.

29. The network entity of claim 22, wherein the transmission of the early termination indicator is based on receipt of a threshold number of end of TX traffic indicators.

30. The network entity of claim 22, wherein the transmission of the early termination indicator is based on a latency parameter associated with a user equipment (UE) from which the early termination indicator is received and latency parameters associated with one or more other UEs within a serving cell of the network entity.
